(19) United States
(12) Patent Application Publication
(10) Pub. No.: US 2018/0002158 A1
(43) Pub. Date: Jan. 4, 2018

(54) METHOD, TOOL AND SYSTEM FOR PRODUCING A PRODUCT FROM A FIBER MATERIAL

(71) Applicant: Schukra Gerätebau GmbH, Berndorf (AT)

(72) Inventors: Darko KRISTO, Teesdorf (AT); Heinrich EISMAYER, Traiskirchen (AT); Zoran VUJANOVIC, Kottingbrunn (AT); Peter KITZBERGER, Berndorf (AT); Jan PETZEL, Tübingen (DE); Georg KÖNCZÖL, Wien (AT)

(21) Appl. No.: 15/543,899

(22) PCT Filed: Jan. 16, 2015
(86) PCT No.: PCT/EP2015/050758

§ 371 Date: Jul. 14, 2017

(51) Int. Cl. B68G 3/00; B29C 43/00; B68G 15/00; B29C 33/34; B29C 35/04; B68G 7/02; B29K 77/00; B29K 67/00; B29K 105/00; B29L 31/00

(52) U.S. Cl. CPC B68G 3/00; B29C 35/045; B29C 43/006; B68G 15/00; B68G 7/02; B29C 33/34; B29K 2067/00; B29K 2105/251; B29L 2031/771; B29K 2077/00

(57) ABSTRACT

A fiber material is filled into a cavity of a tool to produce a product from the fiber material. The tool comprises a mold which defines the cavity therein and a holder which supports the mold. The holder is displaced to move the mold to at least one thermal treatment station The fiber material is thermally treated in the mold at the at least one thermal treatment station.

### FIELD OF THE INVENTION

Embodiments of the invention relate to a method, a tool and a system for producing a product. Embodiments of the invention relate in particular to a method, a tool and a system for producing a product having resilient characteristics, which may be a cushion body, from a fiber material.

### BACKGROUND OF THE INVENTION

Foams, such as polyurethane (PU) foams, are widely used as fabric backings for seats, such as for vehicle interior materials in the transportation industry. The foams are adhered to the backs of textile face materials. These foam backed composites have a cushion effect which can offer comfort or a luxurious feel in contact areas.

There are drawbacks to using polyurethane foam as cushioning material for seats. For example, the polyurethane foam backed material can emit volatile materials which contribute to ‘fogging’ of vehicle or housing interiors, and the foam itself may oxidize over time leading to a color change in the material. Recyclability is also an issue which has to be addressed.

For these and other reasons, there is a continued need for another material that would provide cushion properties similar to the ones of foam materials at similar costs. One class of materials which has received attention in this regard is nonwovens, for example polyester nonwovens. These materials can provide a suitable backing to many face fabrics.

Techniques for producing products such as seat cushion bodies from fiber material may comprise a thermal treatment. A template body or loose fiber material may be supplied into a tool and may be subject to thermal treatment in the tool. Conventional techniques in which the acts of inserting fiber material into the tool and thermal treatment are performed at the same location may have various shortcomings. For illustration, such conventional techniques may suffer from reduced flexibility and efficiency because a new filling step can only be performed when the thermal treatment in the tool has been completed. Energy consumption may be high because of the thermal mass of the tool. Further, the heating and cooling of the complete tool may increase processing times.

### BRIEF SUMMARY OF THE INVENTION

In view of the above, there is a continued need in the art for a tool, an apparatus, a system and a method of producing a product from fiber material which address some of the above needs. There is in particular a need in the art for devices, systems and methods for producing a seat cushion body or other product with good energy efficiency.

These and other needs are addressed by devices, systems and methods according to embodiments. According to exemplary embodiments, a tool may comprise a mold and a holder which holds the mold. Such a composite structure of the tool allows energy efficiency to be improved because only the mold but not the holder may be exposed to a gas flow which heats or cools the fiber material in the mold.

The holder may be used for positioning the mold in a filling station or thermal treatment station of system. The holder may also be used for transporting the tool including the mold from a filling station to at least one thermal treatment station, or for transporting the tool including the mold from one thermal treatment station to another thermal treatment station.

A method of producing a product according to an embodiment comprises filling fiber material into a cavity of a tool, the tool comprising a mold which defines the cavity therein and a holder which supports the mold. The method comprises displacing the holder to move the mold to at least one thermal treatment station. The method comprises thermally treating the fiber material in the mold at the at least one thermal treatment station.

The fiber material may be supplied into the cavity as loose fiber material.

The method may comprise cutting at least one yarn to produce the loose fiber material.

A heat capacity of the mold may be smaller than a heat capacity of the holder. To this end, the mold may have a mass which is less than a mass of the holder.

The tool may comprise a thermal decoupling member interposed between the mold and the holder.

The thermal decoupling member may comprise an interconnection extending between the mold and the holder, the interconnection having a cross section which is less than a surface area of the mold. The interconnection may have a cross section which is much smaller than the surface area of the mold.

The interconnection may comprise a plurality of rods which are spaced from each other.

The at least one thermal treatment station may comprises an adapter configured to couple to the mold for thermally treating the fiber material.

The adapter may comprise a baffle to direct a gas flow into the mold. The baffle may prevent the gas flow from impinging onto the holder.

The at least one thermal treatment station may heat or cool the gas flow before it is directed into the mold.

The at least one thermal treatment station may comprise a heating station comprising a heating station adapter configured to couple to the mold, and a cooling station comprising a cooling station adapter configured to couple to the mold.

The heating station adapter may comprise a baffle which extends between the mold and the holder when the tool is positioned at the heating station.

The cooling station adapter may comprise a baffle which extends between the mold and the holder when the tool is positioned at the cooling station.

The method may comprise displacing the holder to move the mold from the heating station to the cooling station.

The mold may be coupled sequentially to the heating station adapter and to the cooling station adapter.

The fiber material may be filled into the cavity at a filling station which is spaced from the at least one thermal treatment station.

The holder may be automatically displaced from the filling station to the at least one thermal treatment station by an automatic transport mechanism.

The filling station may comprise a filling station adapter to couple to the mold. The filling station adapter may comprise an actuator which displaces at least two sections of the mold relative to each other.

The filling station adapter may comprise a baffle which extends between the mold and the holder when the tool is positioned at the filling station.

The product may be a fiber cushion body.

The filling station may be configured to direct fibers inserted into the mold along a load direction of the fiber cushion body.

A tool for producing a product according to an embodiment comprises a mold which defines a cavity for receiving fiber material therein. The tool comprises a holder which supports the mold and which is displaceable to move the mold from a filling station for filling fiber material into the mold to at least one thermal treatment station.

A heat capacity of the mold may be smaller than a heat capacity of the holder.

The tool may further comprise a thermal decoupling member interposed between the mold and the holder.

The thermal decoupling member may comprise an interconnection extending between the mold and the holder, the interconnection having a cross section which is less than a surface area of the mold. The interconnection may have a cross section which is much smaller than the surface area of the mold.

The interconnection may comprise a plurality of rods which are spaced from each other. The plurality of rods may extend between the mold and the holder.

The mold may comprise a plurality of segments which are displaceable relative to each other.

The plurality of segments may comprise at least one perforated face which permits passage of gas into or out of the mold.

The tool may be configured for producing a fiber cushion body.

According to another embodiment, there is provided a processing station for producing a product. The processing station may comprise an adapter configured to couple to the mold of a tool according to an embodiment.

The adapter may comprise a baffle which guides gas into or out of the mold while preventing the gas from impinging onto the holder.

The processing station may be a filling station. The adapter may be a filling station adapter configured to displace at least one of several segments of the mold relative to at least another one of several segments of the mold.

The filling station may be configured to orient fibers along a load direction of a fiber cushion body.

The processing station may be a thermal treatment station. The thermal treatment station may be configured to heat or cool a gas flow before the gas flow is directed into the mold via the adapter.

A system for producing a product according to an embodiment comprises the tool according to an embodiment.

The system may comprise a filling station for filling fiber material into the cavity of the mold. The system may comprise at least one thermal treatment station for thermally treating the fiber material in the mold.

The at least one thermal treatment station may comprise an adapter configured to couple to the mold for thermally treating the fiber material.

The adapter may be configured to direct a gas flow into the mold and to prevent the gas flow from impinging onto the holder.

The thermal treatment station may be configured to heat or cool the gas flow before it is directed into the mold.

The filling station may comprise a filling station adapter. The filling station adapter may comprise a baffle which guides gas into or out of the mold while preventing the gas from impinging onto the holder.

The filling station adapter may be configured to displace at least one of several segments of the mold relative to at least another one of several segments of the mold.

The system may further comprises a transport mechanism for displacing the holder to the at least one thermal treatment station.

The holder may comprise an engagement feature in engagement with the transport mechanism.

The devices, systems and methods for producing a product from fiber material according to various aspects and embodiments provide a tool which comprises various parts, thereby mitigating the energy efficiency problems associated with heating the complete tool.

The devices, systems and methods according to various aspects and embodiments may be used for producing seat cushion bodies for various types of seats, including seats for automobiles, aircrafts and trains and seats for office or home seating.

### BRIEF DESCRIPTION OF THE DRAWINGS

Embodiments of the invention will be described with reference to the accompanying drawings in which like reference numerals designate like elements.

FIG. 1 is a schematic view of a system according to an embodiment.

FIG. 2 is a schematic view of the system of FIG. 1 when a tool has been displaced between different processing stations.

FIG. 3 is a perspective view of a tool according to an embodiment.

FIG. 4 is another perspective view of the tool of FIG. 3.

FIG. 5 is a perspective view of a system according to an embodiment.

FIG. 6 is a perspective view of the system of FIG. 5 when an adapter of a processing station is coupled to a mold.

FIG. 7 is a perspective view of the system of FIG. 5 when an adapter of a processing station is coupled to a mold.

FIG. 8 is a schematic view of a system according to an embodiment.

FIG. 9 is a schematic view of a system comprising a processing station and a tool according to an embodiment.

### DESCRIPTION OF EMBODIMENTS

Exemplary embodiments of the invention will now be described with reference to the drawings. While some embodiments will be described in the context of specific fields of application, the embodiments are not limited to this field of application. Further, the features of the various embodiments may be combined with each other unless specifically stated otherwise.

While some embodiments will be described in the context of products which are fiber seat cushion bodies, the tools, systems and methods according to embodiments may also be used for forming other products of a fiber material.

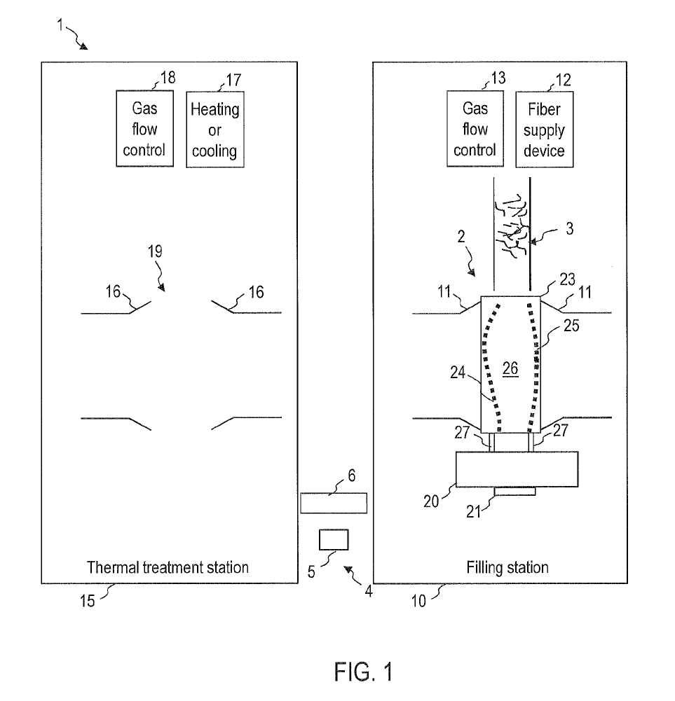

FIG. 1 is a schematic view of a system 1 for producing a product which may be a seat cushion body. The system 1 comprises a tool 2. The system 1 may comprise processing stations. For illustration, the system 1 may comprise a filling station 10 in which fiber material is supplied into a cavity of the tool 2. The system 1 may comprise one or several thermal treatment station(s) 15 for thermal treatment of the fiber material received in the cavity of the tool 2.

As will be described in more detail below, the tool 2 comprises a holder 20 and a mold 23 supported by the holder 20. This configuration of the tool in which the tool 2 is partitioned into the mold 23 defining the cavity and the holder 20 provides improved energy efficiency. In particular, heating and/or cooling operations may be performed in such a way that a gas for heating or cooling the fiber material passes through at least one face of the mold 23, but does not significantly heat or cool the holder 20, respectively.

The holder 20 and the mold 23 may be interconnected by one or several interconnections 27. The one or several interconnections 27 may provide a thermal decoupling between the holder 20 and the mold 23 by limiting heat transfer from the mold 23 to the holder 20. To this end, the one or several interconnections 27 may have a cross-section which is smaller than, and which may be much smaller than, a total surface area of the mold 23. Alternatively or additionally, the one or several interconnections 27 may be formed from a material having a heat conductivity which is less than a heat conductivity of the holder 27.

The mold 23 may have a thermal capacity which is less than a thermal capacity of the holder 20. To this end, the mold 23 may be formed to have a mass which is less than a mass of the holder 20. Thereby, only the mold 23 which has the smaller heat capacity must be heated or cooled when thermally treating the fiber material. Energy efficiency of the production process is improved.

The mold 23 may define a cavity 26 therein. The mold 23 may comprise a plurality of segments 24, 25. One or several of the plurality of segments 24, 25 may comprise passages for allowing passage of gas in the filling station 10 and/or the at least one thermal treatment station 15. The plurality of segments 24, 25 may be displaceable relative to each other. For illustration, one segment 24 comprising gas passages may be displaceable relative to another segment 25 comprising additional gas passages. Displacement of the segments 24, 25 may be effected by an actuator which may be integrated into the mold 23 or which may be integrated into an adapter of the filling station 10 or another processing station 15.

The holder 20 may comprise an engagement section 21 for engagement with a transport mechanism 4 of the system 1. The transport mechanism 4 may be configured to automatically displace the tool 2 from one processing station to another processing station. For illustration, the transport mechanism 4 may be configured to displace the tool 2 by acting on the engagement section 21 of the holder 20. The transport mechanism 4 may be configured such that it does not directly attach to the mold 23 when transporting the tool 2.

The transport mechanism 4 may comprise a guide member 6 for guiding the displacement of the tool 2. The guide member 2 may comprise a guide rod, a conveyor belt, at least one chain, or another component which extends between processing stations of the system 1.

The transport mechanism 4 may comprise an actuator 5 which effects a displacement of the tool 2 from one processing station to at least one other processing station. For illustration, the actuator 5 may drive a conveyor belt, chain or other drivable component to displace the tool 2 from the filling station 10 to at least one thermal treatment station 15.

The filling station 10 may comprise a filling station adapter 11 which couples to the mold 23. The filling station adapter 11 may be configured to direct a gas flow between the mold 23 and at least one gas duct. The filling station adapter 11 may be configured to prevent the gas flow from impinging onto the holder 20. The filling station adapter 11 may comprise a baffle which extends between the holder 20 and the mold 23 when the tool 2 is positioned in the filling station 10 and the filling station adapter 11 engages the mold 23.

The filling station 10 may comprise a fiber supply device 12. The fiber supply device 12 may be configured to provide fiber material 3 in the form of loose fibers or flocks of fibers into the mold 23. In some implementations, the fiber supply device 12 may comprise a cutter device to cut at least one yarn into segments to form the fiber material 3.

The fiber material 3 may comprise binding fibers and matrix fibers. In the mold 23, at least the binding fibers may be thermally activated when the tool 2 is positioned in a thermal treatment station 15. The product, e.g. a fiber cushion body, may be formed as an integral body of cross-linked fibers. Cross-linking may be attained by thermal activation of the binding fibers. The seat cushion body may be formed such that the fibers in at least a portion of the seat cushion body are predominantly oriented along a main load direction of the seat cushion body.

To orient the fibers in the product, the filling station 10 may comprise a gas flow control 13. The gas flow control 13 may generate a gas flow which passes through the mold 23 and which orients the fibers in the mold 23 such that, in at least a portion of the product, the fibers are predominantly oriented along the main load direction.

The fiber material from which the seat cushion body is formed may include fibers that can be obtained from recycling material and/or which can be recycled in an efficient manner. The binding fibers may be bi-component (BiCo) fibers. The binding fibers may have a thermal activation temperature which is lower than a melting temperature of the filling fibers.

According to exemplary embodiments, the binding fibers may be BiCo fibers having a core of polyester or polyamide, and having a coating of polyamide or modified polyester. The BiCo fibers may have a trilobal shape in cross-section. The filling fibers may be formed from polyester or polyamide and have a melting temperature higher than at least the melting temperature of the coating of the binding fibers. The filling fibers may have a linear mass density of in between 10 and 100 dtex. The binding fibers may have a linear mass density of in between 7 and 40 dtex. The fiber material from which the seat cushion body is formed may include more than one type of filling fiber and/or more than one type of binding fiber.

The mold 23 with the fiber material received therein may be displaced from the filling station 10 for thermal activation of the binding fibers. The system 1 may cause the filling station adapter 11 to disengage from the mold 23. The filling station adapter 11 may be withdrawn from the mold 23 to allow the tool 2 with the fiber material received in the mold 23 to be displaced from the filling station 10 to at least one thermal treatment station.

A control device of the system may control the transport mechanism 4 to displace the tool from the filling station 10 to the thermal treatment station 15. The thermal treatment station 15 defines receptacle 19 for receiving the tool 2 therein.

The thermal treatment station 15 may comprise a thermal treatment adapter 16 which couples to the mold 23. The thermal treatment adapter 16 may be configured to direct a gas flow between the mold 23 and at least one gas duct. The thermal treatment adapter 16 may be configured to prevent the gas flow from impinging onto the holder 20. The thermal treatment adapter 16 may comprise a baffle which extends between the holder 20 and the mold 23 when the tool 2 is positioned in the thermal treatment station 15 and the thermal treatment adapter 16 engages the mold 23.

The thermal treatment station 15 may comprise a heating device 18 configured to heat the gas flow before it is supplied into the mold or a cooling device 18 configured to cool the gas flow before it is supplied into the mold. The cooling device may be omitted, e.g. when using ambient temperatures for cooling the fiber material in the mold.

The thermal treatment station 15 may comprise a gas flow control device 18. The gas flow control device 18 controls the gas flow passing through the mold 23 when heat is supplied, e.g. for thermally activating the binding fibers, and/or when the product formed of the cross-linked fibers is cooled by supplying ambient air.

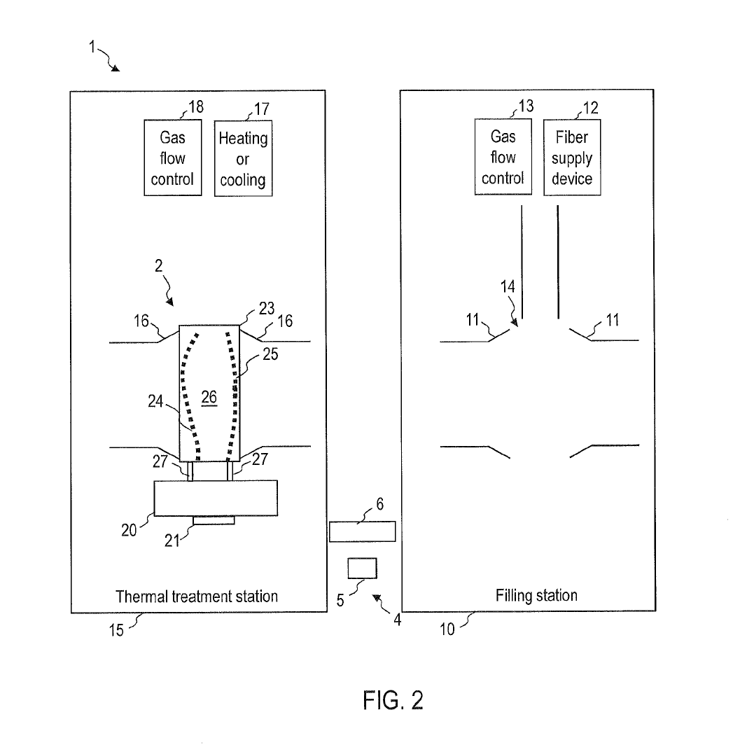

FIG. 2 shows the system 1 with the tool 2 displaced from the filling station 10 to the thermal treatment station 15. After the product, e.g. a fiber cushion body, is removed from the tool 2, the tool 2 may be displaced back to the filling station 10 by the transport mechanism 4.

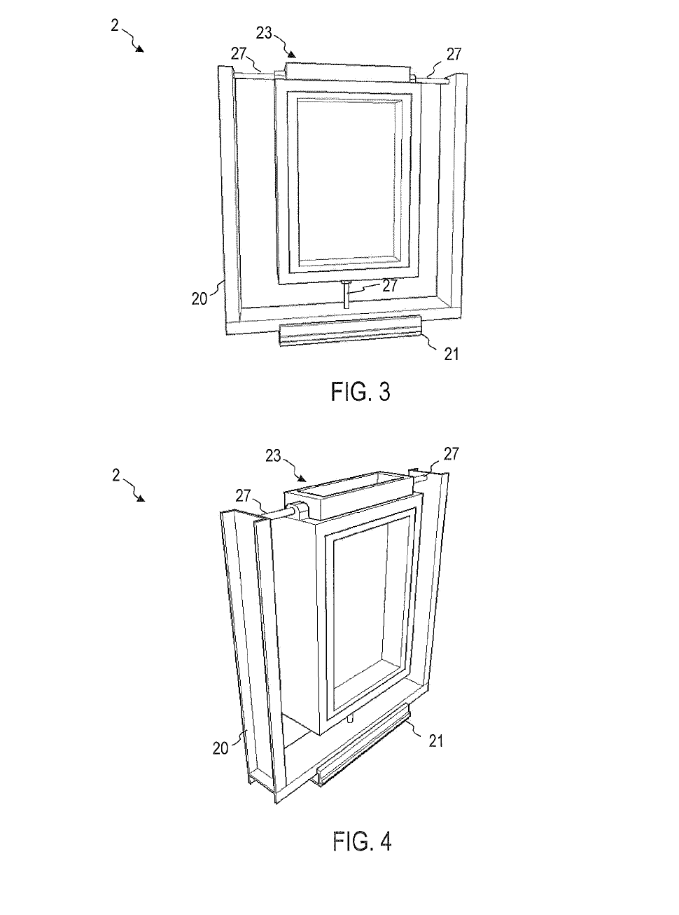

Features of the tool 2 according to exemplary embodiments will be described in more detail with reference to FIG. 3 to FIG. 7.

FIG. 3 and FIG. 4 shows perspective views of a tool 2 according to an embodiment.

The tool 2 includes the mold 23 and the tool holder 20. Several adapters may be configured for coupling to the mold 23 and may be installed in different processing stations, such as filling, heating and/or cooling stations. The adapters may remain on the respective processing stations when the tool holder 20 and the mold 23 move from one station to the next.

The mold 23 may act as a shaping device which comprises elements to define the external shape of the product. The mold 23 may comprise all elements required to define the external shape of the product.

The mold 23 may optionally include elements for mechanically compressing the fiber material in the mold 23. For illustration, the mold 23 may comprise perforated segments 24, 25 which are displaceable relative to each other.

The mold 23 may optionally include a locking mechanism for locking the displaceable segments 24, 25 relative to each other in a desired position. The locking mechanism may be configured to lock the displaceable segments 24, 25 in their position after at least one of the displaceable segments 24, 25 was displaced for compressing the fiber material in the mold 23. Such a locked position provides the geometry of the product and may be maintained throughout the heating and cooling process.

The tool holder 20 may be provided such that it is substantially thermally decoupled from the mold 23 to keep the thermal mass which needs to be heated and cooled in the production process small. Thereby, only the mold 23 must be heated inside the heating station and cooled again in the cooling station. The tool holder 20 stays outside the volume in which thermal treatment is provided and will therefore not add to the thermal losses.

Thermal conductivity between the holder 20 and the mold 23 may be reduced by using interconnections 27 which mechanically couple the mold 23 to the holder 20 while reducing thermal energy flow through the interconnections 27. The interconnections 27 may comprise a plurality of rods which are spaced from each other to keep low the cross section of the material extending between the holder 20 and the mold 23. The interconnections 27 may have a cross-section which is smaller than a total surface area of the mold 23. The interconnections 27 may have a cross-section which is much smaller than a total surface area of the mold 23.

The mold 23 may have two opposing major faces. On the major faces, passages for allows a gas flow therethrough may be provided. The mold 23 may have an additional opening for receiving fiber material into the mold. The opening for receiving fiber material may be provided at an upper end face of the mold 23.

An engagement section 21 of the holder 20 may be configured for coupling to the transport mechanism 4. For illustration, the engagement section 21 may comprise at least one projection or at least one recess for engagement with the transport mechanism 4. The engagement section 21 may be received in a guide rail of the transport mechanism 4, for example.

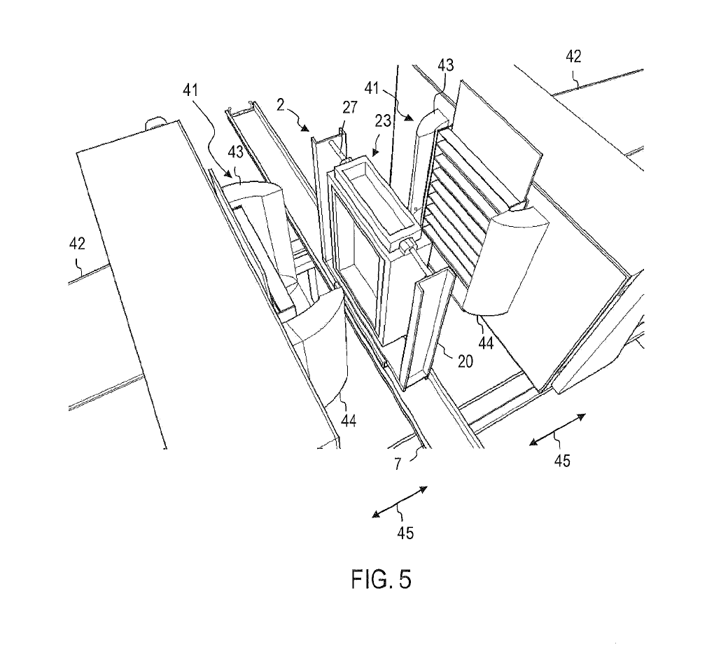

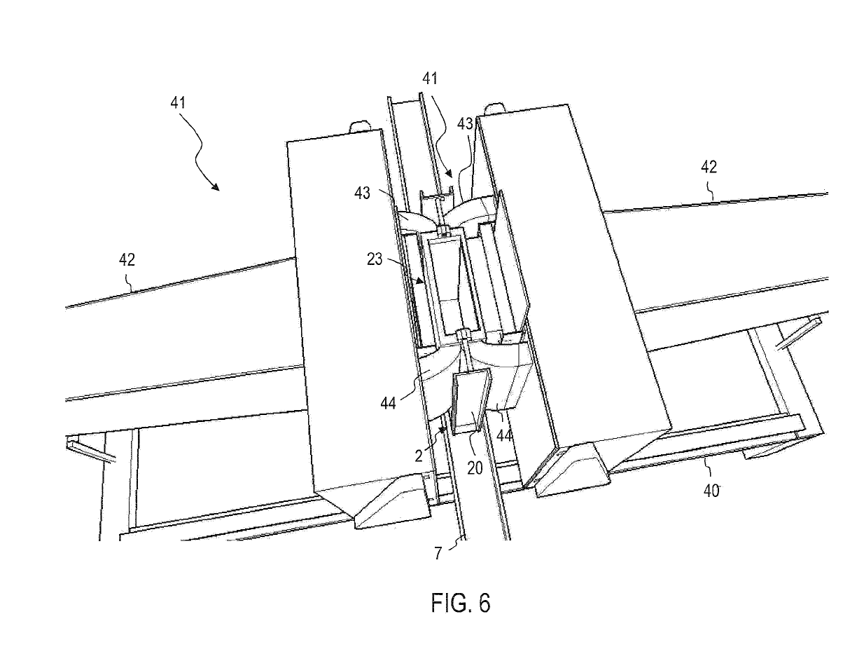

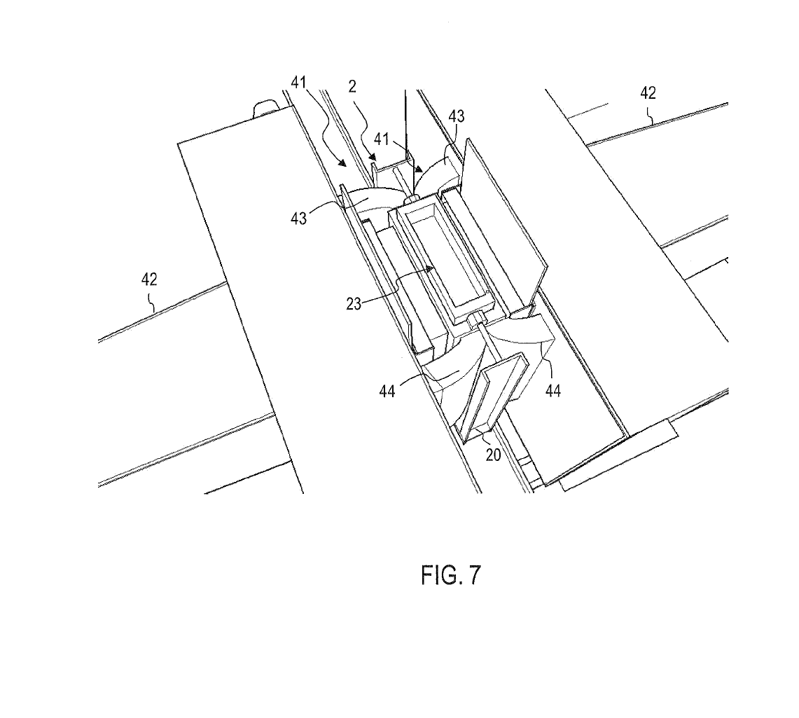

FIG. 5 is a perspective view of a system comprises a processing station and a tool according to an embodiment. FIG. 6 and FIG. 7 are perspective views of the system when an adapter 41 of the processing station is engaged with the mold 23.

The processing station may be a filling station for filling fiber material into the mold. The processing station may be a heating station for supplying heat to the fiber material in the mold. The processing station may be a cooling station for cooling the product with cross-linked fiber material in the mold.

The processing station comprises at least one gas duct 42. The processing station may comprise two gas ducts 42. Gas may be withdrawn from the mold 23 through both gas ducts. Alternatively, gas may be supplied into the mold 23 through one of the gas ducts 42 and may be withdrawn from the mold 23 through the other one of the gas ducts 42.

The processing station may comprise an adapter 41 for interfacing a gas duct 42 with the mold 23. The adapter 41 may be configured to engage the mold. The processing station may also comprise several adapters 41 for interfacing the mold 23 with several gas ducts.

The adapter 41 may be configured to allow gas to pass between the mold 23 and a gas duct 42, through a section 24, 25 of the mold which includes passages and through the adapter 41.

The adapter 41 may be displaceable. The adapter 41 may be configured to be displaced relative to the tool 2 to selectively engage the tool 2 and disengage from the tool 2. The adapter 41 may be guided for displacement 45 in a direction towards and away from major faces of the mold 23.

The adapter 41 may comprise at least one baffle 42, 43. The at least one baffle 42, 43 may be configured to engage a side face of the mold 23. The at least one baffle 42, 43 may be configured to extend into a space between the mold 23 and the holder 20 when the adapter 41 engages the mold 23. Such a configuration allows the adapter 41 to prevent the gas flow from impinging also onto the holder 20.

The adapter 41 may define a volume for heating and/or cooling fiber material, with the mold 23 being positioned within the volume for heating and/or cooling fiber material and the holder 20 being positioned outside the volume for heating and/or cooling fiber material when the adapter 41 engages the mold 23.

The adapter 41 may be displaced into engagement with the mold 23, as illustrated in FIG. 6 and FIG. 7. The adapter 41 may then prevent a gas flow passing out of or into the mold from impinging onto the holder 20. The adapter 41 may form a sealing between the adapter and the mold 23.

Different features may be integrated into the adapter 41. Adapters 41 provided in the filling station and the thermal treatment station(s) may have different configurations.

For a filling station, the filling station adapter 41 may be configured such that it allows gas to flow into the mold 23 at one side of the mold and that it allows gas to be withdrawn from at least to other sides of the mold 23. The filling station adapter 41 may be configured to allow gas to be drawn into the mold 23 at a minor face of the mold 23, e.g. at a top face. The filling station adapter 41 may be configured to allow gas to be discharged from the mold 23 at opposing major faces of the mold 23. The gas flow can pass the perforated mold segments 24, 25 while leaving the fiber material deposited in the mold 23.

The filling station adapter 41 may also include at least one device for controlling the location(s) at which the gas can leave the mold 23 through the adapter 41. For illustration, the location(s) at which gas is discharged through the perforated mold segments 24, 25 may be varied in dependence on a fiber filling level in the mold 23.

The filling station adapter 41 may be configured to displace at least one segment of the mold 23 relative to at least one other segment. For illustration, the filling station adapter 41 may comprise an actuator to displace a mold segment 24 relative to another mold segment 25 to compress the fiber material. Increased density and/or a spatial change in fiber orientation may be attained thereby. Alternatively or additionally, the filling station adapter 41 may comprise an actuator to displace mold segments on minor faces of the mold 23 to compress the fiber material.

The filling station adapter 41 may be configured to activate a locking mechanism integrated in the mold 23 which locks different segments of the mold 23 in their relative position. For illustration, when a desired compression is attained, the filling station adapter 41 may actuate a locking mechanism of the mold 23 to lock the mold segments 24, 25 in their relative position.

For a heating station, the heating station adapter 41 may be configured such that it allows gas to flow into the mold 23 at one side of the mold and that it allows gas to be withdrawn from another side of the mold 23. The heating station adapter 41 may shut off all other sides of the mold 23. The heating station adapter 41 may be configured to allow gas to be drawn into the mold 23 at a major face of the mold 23, e.g. at through the perforated sheet 24, and that it allows the gas to be discharged from the mold 23 at an opposing major face of the mold 23, e.g. through the perforated sheet 25.

The heating station adapter 41 may also include at least one device for controlling the location(s) at which the gas can enter and leave the mold 23 through the adapter 41.

The heating station adapter 41 may be configured to displace at least one segment of the mold 23 relative to at least one other segment. For illustration, the heating station adapter 41 may comprise an actuator to displace a mold segment 24 relative to another mold segment 25 to compress the fiber material if such a compression is desired during thermal treatment. Increased density and/or a spatial change in fiber orientation may be attained thereby. Alternatively or additionally, the heating station adapter 41 may comprise an actuator to displace mold segments on minor faces of the mold 23 to compress the fiber material.

For a cooling station, the cooling station adapter 41 may be configured such that it allows gas to flow into the mold 23 at one side of the mold and that it allows gas to be withdrawn from another side of the mold 23. The cooling station adapter 41 may shut off all other sides of the mold 23. The cooling station adapter 41 may be configured to allow gas to be drawn into the mold 23 at a major face of the mold 23, e.g. at through the perforated sheet 24, and that it allows the gas to be discharged from the mold 23 at an opposing major face of the mold 23, e.g. through the perforated sheet 25.

The cooling station adapter 41 may also include at least one device for controlling the location(s) at which the gas can enter and leave the mold 23 through the adapter 41.

The cooling station adapter 41 may be configured to displace at least one segment of the mold 23 relative to at least one other segment. For illustration, the cooling station adapter 41 may comprise an actuator to displace a mold segment 24 relative to another mold segment 25 to compress the fiber material if such a compression is desired during thermal treatment. Increased density and/or a spatial change in fiber orientation may be attained thereby. Alternatively or additionally, the cooling station adapter 41 may comprise an actuator to displace mold segments on minor faces of the mold 23 to compress the fiber material.

The cooling station adapter 41 may be configured to unlock the locking mechanism integrated in the mold 23 which locks different segments of the mold 23 in their relative position. For illustration, when the product can be removed from the mold 23, the cooling station adapter 41 may unlock the locking mechanism to facilitate removal of the product from the mold 23.

The system 1 according to embodiments may comprise more than two processing stations. For illustration, the system 1 may comprise a filling station 10, a heating station for thermally activating the binding fibers, and a cooling station for cooling the product in the mold 23. Additional processing stations may be provided to implement more complex thermal cycling.

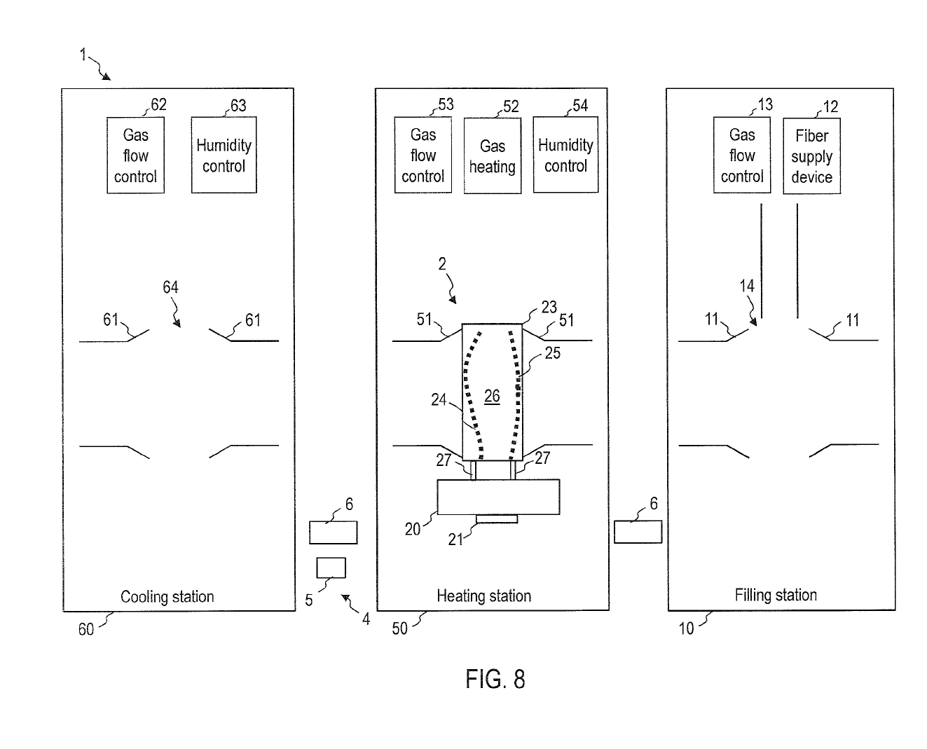

FIG. 8 shows a system 1 according to an embodiment. The system 1 comprises a tool 2. The system 1 may comprise processing stations. For illustration, the system 1 comprises a filling station 10 in which fiber material is supplied into a cavity of the tool 2. The system 1 comprises several thermal treatment stations for thermal treatment of the fiber material received in the cavity of the tool 2. The several treatment stations comprise a heating station 50 and a cooling station 60. The filling station 10 may be configured as explained with reference to FIG. 1 to FIG. 7 above. The filling station 10 may in particular be configured to fill a fiber material which comprises a blend of binding fibers and filling fibers into the mold 23.

The heating station 50 may be configured to thermally activate the binding fibers for thermal cross-linking. The heating station 50 may comprise a heating station adapter 51, a heating device 52 for heating a gas, and a gas flow control device 53 for controlling a gas flow through the mold 23 when the tool 2 is positioned at the heating station 50. These components may be configured as explained with reference to FIG.

1 to FIG. 7 above.

The heating station 50 may comprise an air humidity control device 54 to control air humidity during thermal activation of the binding fibers.

The cooling station 60 may be configured to thermally activate the binding fibers for thermal cross-linking. The cooling station 60 may comprise a cooling station adapter 61 and a gas flow control device 62 for con-trolling a gas flow through the mold 23 when the tool 2 is positioned at the cooling station 60. These components may be configured as explained with reference to FIG. 1 to FIG. 7 above. The cooling station 60 may comprise an air humidity control device 63 to control air humidity while the product is being cooled down.

The cooling station 60 has a receptacle 64 for receiving the tool 2. The cooling station adapter 61 may be engaged with and disengaged with the tool 2. This may be done in such a way that a cooling volume for cooling the product is defined by the cooling station adapter 61. The mold 23 may be positioned within the cooling volume, while the holder 20 remains positioned outside the cooling volume.

The transport mechanism 4 may position the tool 2 sequentially at the filling station 10, at the heating station 50, and at the cooling station 60. In each operating cycle, the tool 2 may be positioned at least once at each one of the filling station 10, the heating station 50, and the cooling station 60. More complex motion patterns for the tool 2 may be implemented, e.g. by implementing a reciprocating movement between two or more thermal treatment stations.

The system 1 may comprise additional stations. For illustration, one or several post-treatment stations may be provided for modifying the product after it has been cooled down. Alternatively or additionally, more than two thermal treatment stations may be provided.

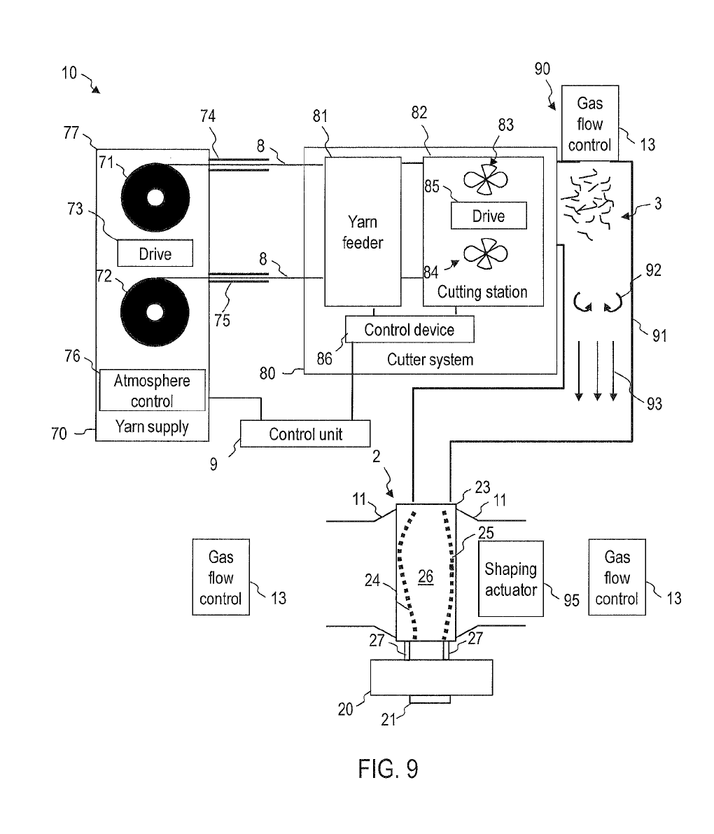

The filling station 10 may have any one of a variety of configurations. In some implementations, the filling station 10 may use flocks of fiber material as raw material and may separate the flocks into filaments for filling the fibers into the mold. In other implementations, the filling station 10 may use one or several yarns as raw material and may cut the yarn(s) into segments for supplying the fiber material into the mold, as illustrated in FIG. 9.

FIG. 9 shows a system comprising a filling station 10 which includes a cutting device and a tool 2 according to an embodiment.

The filling station 10 uses yarn(s) as raw material, cuts the yarns into segments to produce binding fibers and matrix fibers, and transports the binding fibers and matrix fibers into a mold 23 of a tool 2. In the mold 23, at least the binding fibers may be thermally activated. A seat cushion body or other product may thereby be formed as an integral body of cross-linked fibers. Cross-linking may be attained by thermal activation of the binding fibers. The product may be formed such that the fibers in at least a portion of the seat cushion body are predominantly oriented along a main load direction of the seat cushion body.

The filling station 10 comprises a cutter system 80 configured to cut one or more yarns 8 to produce the fiber material from which the seat cushion body is formed. The filling station 10 comprises a transport mechanism 30 configured to transport the fibers away from cutting blades of the cutter system 80 and into the mold 23.

The filling station 10 may comprise a yarn supply device 70 configured to supply the one or more yarns 8 to the cutter system 80. The yarn supply device 70 may include one or more spools 71, 72 of yarn. The spools 71, 72 may be formed from the same yarn or from different yarns. Each spool 71, 72 may be mounted on a rotatably supported which may be driven by a power drive 73 to play out yarn from the spools 71, 72.

The yarn supply device 70 may have an enclosure 77 in which the spool(s) 71, 72 of yarn are housed. Environmental parameters of the yarn when stored within the enclosure 77 may be controlled by an atmosphere control device 76 of the yarn supply device 70. The enclosure 77 has an atmosphere within its interior. The atmosphere control device 76 may be configured to control air humidity and/or a temperature of the atmosphere within the enclosure 77.

The atmosphere control device 76 may be configured to control the air humidity and temperature within the enclosure 77 in which the yarn is stored such that the yarn(s) supplied by the yarn supply device 70 have a material humidity of at least 2.5%. This has proven to result in seat cushion bodies providing good comfort when the yarn(s) are cut to produce the fiber material.

The yarn supply device 70 may comprise at least one channel 74, 75 which extends towards the cutter system 80. The at least one channel 74, 75 may be in fluid communication with the atmosphere which is maintained within the enclosure of the yarn supply device 70. The at least one channel 74, 75 may be configured as a tube extending from the enclosure 77. The yarn(s) 8 may be guided in the at least one channel 74, 75. The yarn(s) 8 may be conveyed from the yarn supply device to the cutter system 80 through the channels 74, 75 in such a manner that the yarn(s) 8 are exposed to ambient atmosphere for at most a short distance of their transport to cutting blades of the cutter system.

The yarn(s) 8 may respectively be composed of a plurality of filaments. The filaments may be staple fibers or endless filaments. Filaments of different cross sections, materials and/or diameters may be included in the yarn(s) 8.

While two yarns 8 and two spools 71, 72 of yarn are shown in FIG. 9, other numbers of yarns may be used. For illustration, at least four yarns may be supplied from the yarn supply device 70 to the cutter system 80. The yarn supply device 70 may be configured to output four or more than four yarns to the cutter system 80. The yarn supply device 70 may be configured to output from four to sixteen yarns to the cutter system 80.

The cutter system 80 is configured to cut the yarns supplied thereto into segments. Both binding fibers and matrix fibers for forming the seat cushion body may be produced by cutting the yarn(s) into segments. At least some of the yarn(s) may consist of a blend of different materials such that segments of a first filament may act as matrix fibers and segments of a second filament may act as matrix fibers.

The cutter system 80 comprises one or more cutting blades 83, 84 for cutting the yarn(s) into segments. For illustration, a rotating cutting blade 83, 84 may be provided for cutting the yarn 8. A cutting head which includes the rotating cutting blade 83, 84 may include a fixed or counter rotating cutting edge, with the yarn 8 being cut into segments between the rotating cutting blade 83, 84 and the cutting edge. A sensor may be used to measure the forces and/or torques acting onto the cutting blade 83, 84. Operation of the cutting head may be controlled based on the measured forces and/or torques.

Each cutting head may include a channel for guiding the yarn therethrough. The channel may be configured such that the yarn is advanced towards the respective cutting blade 83, 84 by a gas stream. The gas stream may be generated by the rotation of the respective cutting blade 83, 84, which gives rise to a pressure difference between the outlet of the channel and the inlet of the channel. The pressure difference establishes a gas stream, which advances the yarn towards the cutting head.

A drive 85 is configured to rotationally drive the cutting blades 83, 84 of the cutter system 80. The drive 85 may be controlled by a control device 86. The control device 86 may control the operation of the cutting blades 83, 84 and operation of a yarn feeder 81 of the cutting station in a coordinated manner. The control device 86 may optionally also control the drive 73 of the yarn supply device 70.

The cutter system 80 may comprise a yarn feeder 81. The yarn feeder 81 may include a transport belt or other transport mechanism which advances the yarn(s) 8 from the output of the yarn supply device 70 to a cutting station 82 which includes the rotating cutter blades 83, 84. The yarn feeder 81 may be configured to receive the yarn(s) 8 at a discharge opening of the tubes 74, 75 and to convey the yarn(s) 8 to the cutting station 82. The yarn feeder 81 may comprise one or several conveyer belts, grippers which grip and advance the yarn(s) 8 or other conveying devices.

The cutter system 80 produces fiber material which is cut from the yarn(s) 8. Yarn segments cut from the yarn(s) 8 may at least partially be opened into segments of their filaments by the cutting action of the cutter system 80. The cutter system may comprise an opening mechanism which opens the yarn segments into their filament segments, so as to produce individual filament segments.

The cutter system 80 may be configured such that the lengths of the segments may be adjusted, thereby producing fiber material with fibers of different lengths. The length of the fibers may be adjusted in a controlled way in dependence on the filling level of the fiber material in the mold 23.

The filling station 10 comprises a supply mechanism 90 which transports the fiber material from an output of the cutter system 80 into the mold 23. The supply mechanism 90 may have any one of a variety of configurations. For illustration, mechanically moving conveying elements may be used. The supply mechanism 90 may be configured to generate a gas flow, in particular an air flow, to transport the fiber material from an output of the cutter system 80 to the mold 23 of the tool 2 through an adapter of the filling station. The supply mechanism 90 may comprise one or several gas flow control devices 13 which are operative to establish an air flow from the output of the cutter system 80 to the mold 23. Each of the gas flow control devices 13 may comprise a ventilator or another actuator which is operative to generate a gas flow.

The supply mechanism 90 may be configured to establish a laminar air flow 93 in a guide channel 91. The air flow 93 transports the fiber material away from the cutter system and extends into the mold 23 of the tool 2. The air flow may be guided such that it does not impinge onto the holder 20. In the mold 23, the air flow may be deflected so as to exit the mold through openings in the mold 23. Fibers may be oriented in the mold 23 by this air flow pattern.

The supply mechanism 90 may be configured to assist in separating the cut yarn segments into their constituent filaments. The supply mechanism 90 may generate a flow pattern 92 which assists in separating the cut yarn segments into the segments of their constituent filaments. The supply mechanism 90 may be configured to generate a turbulent or laminar flow field 92 which assists in separating filament segments of the yarn segments from one another. The supply mechanism 90 may comprise one or several mechanical elements arranged in the transport path of the fiber material to assist in separating the cut yarn segments into the segments of the constituent filaments.

The filling station 10 may comprise a central control unit 9. The central control unit 9 may be interfaced with the control device 86 of the cutter system 80. The central control unit 9 may be interfaced with the yarn supply device 70 and/or the supply mechanism 90. The central control unit 9 may control operation of the yarn supply device 70 and the cutter system 80 in a coordinated manner. The central control unit 9 may also control operating of the transport mechanism 4 and/or of at least one thermal treatment station. The central control unit 9 may control operation of the yarn supply device 70, the cutter system 80, and supply mechanism 90 in a coordinated manner.

The central control unit 9 may be omitted or may be integrated into one or several of the functional units of the system 1.

The mold 23 of the tool 2 may comprise a plurality of mold segments 24, 25 which are displaceable relative to each other. The mold 23 may comprise a first half mold 24 and a second half mold 25 which define a cavity 26 therebetween. The first half mold 24 and the second half mold 25 may be configured to be displaced relative to one another before the fiber material 3 disposed in the mold 23 is formed into the seat cushion body by thermally activating at least binding fibers of the fiber material.

The filling station adapter 11 of the filling station 10 may comprise an actuator 96 for displacing at least one half mold 24, 25. Thereby, the density of the fiber material may be varied. Alternatively or additionally, local variations in fiber orientation may be established.

The first half mold 24 and the second half mold 25 may be configured to be locked in their position after at least one of the half molds 24, 25 was displaced relative to the other half mode. The locking mechanism may be integrated into the mold 23. The actuator 96 of the filling station adapter 11 may operate the locking mechanism of the mold 23 to secure the first half mold 24 and the second half mold 25 in their relative position.

Thermal heating of the fiber material in the mold 23 may be performed at a thermal treatment station. The mold 23 may be displaced for thermal activation of the binding fibers by a transport mechanism 4 of the system 1.

The filling station 10 may be configured such that the fiber material produced by cutting the yarn(s) 8 is transported into the mold 23 without being deposited or stored on the way from the cutter system 70 to the mold 23. The fiber material for filling the mold 23 may be produced on site and as required for filling the fiber material into the mold 23.

The filling station 10 may be configured to produce the fiber material in batches. The cutter system 70 may interrupt the production of the fiber material after production of a batch has respectively been completed.

The methods, tools and systems according to embodiments may be used to produce a wide variety of different products. In particular, products having a resilient section may be produced. The methods, tools and systems according to embodiments may be used to produce a product which is a seat cushion body formed from fiber material.

The seat cushion body formed using the methods, tools and systems according to embodiments is a unitary body which is integrally formed from thermally cross-linked fibers. The fiber material forming the seat cushion body may include at least two different types of fibers, namely a binding fiber and a matrix fiber.

The seat cushion body may include a plurality of different portions. The portions may be distinguished from each other with regard to a characteristic fiber orientation and/or a density of the seat cushion body and/or the average fiber length. The seat cushion body may be formed such that there are no sharp boundaries between the different portions. Rather, the seat cushion body produced by the methods, tools and systems according to embodiments may exhibit gradual transitions in fiber orientation and/or seat cushion body density between the different portions.

The seat cushion body may have a resilient portion. The resilient portion has a fiber orientation corresponding to the main load direction of the seat cushion body. I.e., the preferential direction of the fibers in the resilient portion corresponds to the main load direction and is perpendicular to at least one major face of the seat cushion body. Due to the formation of the fiber matrix, fiber shapes and statistical distributions in fiber orientation, not all fiber fibers will be directed along the main load direction 102 in the resilient portion. The resilient portion may be considered to have a fiber orientation along the main load direction if more than 50% of the fibers are respectively oriented at an angle of less than 45° to the main load direction. In other words, in the resilient portion, the majority of fibers is disposed at angle of more than 45° relative to the plane of the major face.

The resilient portion may be formed by orienting the fibers in the mold 23 of the tool 2 prior to applying thermal treatment for activating the binding fibers.

While methods, tools and systems according to embodiments have been described in detail, alterations and modifications may be implemented in further embodiments. For illustration, while systems comprising a filling station and at least one thermal treatment station have been described, the system according to embodiments may include different numbers and types of processing stations.

For further illustration, while gas may be supplied to the mold 23 for filling fibers into the mold or for thermally treating the fiber material in the mold, vapor may also be supplied to the mold. For illustration, water vapor may be added to the gas to control air humidity.

For further illustration, while the adapter of at least one processing station may be configured to couple to the tool 2 in such a way that only the mold 23 is positioned in a volume to which heating or cooling gas are supplied while the holder 20 is positioned outside of this volume, the adapter of at least one other station does not need to have such a configuration. For a cooling station which operates using ambient air, it may not be necessary to prevent the ambient air from impinging onto the holder 20.

The methods, tools and systems according to embodiments may be used for producing a seat cushion which may be integrated into a wide variety of seats. Exemplary seats in which the seat cushion bodies may be used include automobile seats, train seats, aircraft seats, seats for home use and seats for office use. The seat cushion bodies produced by the methods, tools and systems may further be used on various components of the seat. For illustration, a seat cushion body may be used at a seat portion which receives a person's thighs, at a backrest portion supporting a person's back, or at a headrest portion or at another component where cushioning is desired.

The methods, tools and systems according to embodiments may be used for producing a wide variety of three-dimensional products, including seat cushion bodies.

1-22. (canceled)

23. A method of producing a product, the method comprising:
filling fiber material into a cavity of a tool, the tool comprising a mold which defines the cavity therein and a holder which supports the mold,
displacing the holder to move the mold to at least one thermal treatment station, and
thermally treating the fiber material in the mold at the at least one thermal treatment station.

24. The method according to claim 23,
wherein a heat capacity of the mold is smaller than a heat capacity of the holder.

25. The method according to claim 23,
wherein the tool comprises a thermal decoupling member interposed between the mold and the holder.

26. The method according to claim 23,
wherein the at least one thermal treatment station comprises an adapter configured to couple to the mold for thermally treating the fiber material.

27. The method according to claim 26,
wherein the adapter comprises a baffle to direct a gas flow into the mold and to prevent the gas flow from impinging onto the holder.

28. The method according to claim 27,
wherein the gas flow is heated or cooled before it is directed into the mold.

29. The method according to claim 26,
wherein the at least one thermal treatment station comprises:
a heating station comprising a heating station adapter configured to couple to the mold, and
a cooling station comprising a cooling station adapter configured to couple to the mold,
and wherein the method comprises:
displacing the holder to move the mold from the heating station to the cooling station.

30. The method according to claim 29,
wherein the mold is sequentially coupled to the heating station adapter and to the cooling station adapter.

31. The method according to claim 23,
wherein the fiber material is filled into the cavity at a filling station which is spaced from the at least one thermal treatment station.

32. The method according to claim 31,
wherein the holder is automatically displaced from the filling station to the at least one thermal treatment station by an automatic transport mechanism.

33. A tool for producing a product, the tool comprising:
a mold which defines a cavity for receiving fiber material therein, and
a holder which supports the mold and which is displaceable to move the mold from a filling station for filling fiber material into the mold to at least one thermal treatment station.

34. The tool according to claim 33,
wherein a heat capacity of the mold is smaller than a heat capacity of the holder.

35. The tool according to claim 33,
wherein the tool further comprises a thermal decoupling member interposed between the mold and the holder.

36. The tool according to claim 35,
wherein the thermal decoupling member comprises at least one rod extending between the mold and the holder.

37. The tool according to claim 35,
wherein the thermal decoupling member comprises a plurality of rods extending between the mold and the holder, the plurality of rods being spaced from each other.

38. The tool according to claim 33,
wherein the mold comprises a plurality of segments which are displaceable relative to each other.

39. A system for producing a product, comprising:
the tool according to claim 33,
a filling station for filling fiber material into the cavity of the mold, and
at least one thermal treatment station for thermally treating the fiber material in the mold.

40. The system according to claim 39,
wherein the at least one thermal treatment station comprises an adapter configured to couple to the mold for thermally treating the fiber material.

41. The system according to claim 40,
wherein the adapter is configured to direct a gas flow into the mold and to prevent the gas flow from impinging onto the holder.

42. The system according to claim 39,
wherein the thermal treatment station is configured to heat or cool the gas flow before it is directed into the mold.

43. The system according to claim 39,
wherein the system further comprises a transport mechanism for displacing the holder to the at least one thermal treatment station.

44. The system according to claim 43,
wherein the holder comprises an engagement feature in engagement with the transport mechanism.
